(19) United States
(12) Patent Application Publication
(10) Pub. No.: US 2016/0328179 A1
(43) Pub. Date: Nov. 10, 2016

(54) MULTIPLE VIRTUALLY OVER-PROVISIONED, VIRTUAL STORAGE DEVICES CREATED FROM A SINGLE PHYSICAL STORAGE DEVICE

(71) Applicant: Micron Technology, Inc., Boise, ID (US)

(72) Inventor: John Patrick Quinn, Berlin, MA (US)

(21) Appl. No.: 15/149,021

(22) Filed: May 6, 2016

Related U.S. Application Data
(60) Provisional application No. 62/158,899, filed on May 8, 2015.

(51) Int. Cl. G06F 3/06; G06F 12/02

(52) U.S. Cl. CPC G06F 3/0649; G06F 3/0611; G06F 3/0616; G06F 3/064; G06F 3/0688; G06F 12/0246; G06F 12/0253; G06F 2212/1044; G06F 2212/1016; G06F 2212/1036; G06F 2212/2022; G06F 2212/7205

(57) ABSTRACT

Methods are disclosed for partitioning a solid state storage device to create multiple virtual storage devices, which may include one or more virtual tiers of data. Some examples of the methods address self-tiering of the data between the multiple virtual tiers within the physical device. And some examples provide for automatic movement of aging data blocks (i.e. data blocks for which and identified write threshold has been exceeded) to larger over-provisioning pools of blocks to reduce the rate of aging for those blocks.

### BACKGROUND

The present disclosure relates generally to methods and apparatus for managing and controlling solid state memory; and more specifically to methods and apparatus for controlling solid state memory through use of virtual storage devices realized from a single physical storage device, enabling improved methods of wear and age management, and offering, in some embodiments improve performance.

Semiconductor Flash cells (lowest level storage element in a Flash chip) have a finite number of data writes available to them before they start to degrade (after x writes, they are eventually unable to hold their written state, i.e., the written state cannot be reliably read) due to the inherent reliability and impacts of multiple erase/write cycles on the physical cells. After x writes, data written to the device cannot be reliably read, and therefor that data cell cannot be reliably used. Because of this, writes are usually distributed across a larger over-provisioned “pool” of write blocks (OP Blocks). Write block size and counts are architecturally device dependent, and all storage cells within a block are written concurrently. Additionally, each subsequent write to a block requires an erase cycle followed by the write cycle. All storage cells within a write block are erased during an erase cycle, and all cells are re-written on the write cycle.

The write space allocated to a specific write capacity will be over-provisioned by a certain percentage of additional storage capacity in order to help reduce the impact of repeated writes to that same address within that allocated storage capacity. In-direction pointers are typically used in the solid-state storage disks that constantly map and re-map the logical addresses to the actual physical addresses of the storage blocks. Rather than repeatedly writing the same physical cell (as in a direct mapped, fixed physical address schema) the impact of high write rates by the host to a specific address are spread across multiple blocks, thereby reducing the write loading and impact of multiple writes on any specific block. Since previously erased blocks need to be available to the system in order to receive subsequent writes, the processing element that is managing that device is constantly rearranging data to more efficiently store that data, and to free up additional emptied blocks that can be transferred to the OP Block pool, making them available for new writes.

The solid state storage subsystem is constantly rearranging the logical pointers to these blocks of storage in order to “spread” or “wear level” the impact of a repeated write to the same logical address location by the Host (the computer system that is controlling the Input/output-read/write) to that storage device. There are additional device level processes that are ran by the managing processor element in the background to free up (move active user data off) and erase blocks to make them available for next writes.

The Solid State Disk (SSD) also keeps track of the number of writes to each physical storage element (a block of solid state storage cells, block size is architecturally dependent).

### BRIEF DESCRIPTION OF THE DRAWINGS

FIG. 1 is a conceptual representation of an example physical device in the form of a plane of individually addressable blocks.

FIG. 2 is a conceptual representation of an example of multiple virtual devices as may be created from the single physical device of FIG. 1 based on logical addresses.

FIG. 3 is a conceptual representation of an example of multiple physical addresses of the single physical device of FIG. 1 as may be apportioned to form the multiple virtual devices of FIG. 2.

FIG. 4 is a schematic representation of an example of virtual multiple tiered storage device created by allocating addressable blocks to multiple tiers, creating n virtual tiers.

FIG. 5 is a schematic representation of a virtual multiple tiered storage device depicting ratios of data blocks to over-provisioned blocks in the multiple tiers.

FIG. 6 is a block diagram representation of stacking storage devices employing virtualized storage devices built from different technologies.

FIG. 7 is a block diagram representation of an example of tiered storage utilizing devices of different technologies and storage capabilities.

FIG. 8 is a schematic representation of an over-provisioned, virtual multiple tiered storage device with a host writing data to a data block.

FIG. 9 is a schematic representation of the over-provisioned, virtual multiple tiered storage device of FIG. 8, with a write promotion to the next tier.

FIG. 10 is a schematic representation of the over-provisioned, virtual multiple tiered storage device of FIG. 9, following the write promotion.

FIG. 11 is a schematic representation of an over-provisioned, virtual multiple tiered storage device reflecting the read process.

FIG. 12 is a schematic representation of the over-provisioned, virtual multiple tiered storage device of FIG. 10, depicting the demotion of a virtual over-provisioned block.

### DETAILED DESCRIPTION

In the following detailed description of the embodiments, reference is made to the accompanying drawings which form a part hereof, and in which is shown by way of illustration specific illustrative embodiments in which some embodiments of the invention may be practiced.

The following detailed description describes example embodiments of the structure and function of embodiments of the new over-provisioned, virtual multiple tiered storage device in reference to the accompanying drawings, which depict various details of examples that show how the disclosure may be practiced. The discussion addresses various examples of novel methods, systems and apparatus in reference to these drawings, and describes the depicted embodiments in sufficient detail to enable those skilled in the art to practice the disclosed subject matter. Many embodiments other than the illustrative examples discussed herein may be used to practice these techniques. Structural and operational changes in addition to the alternatives specifically discussed herein may be made without departing from the scope of this disclosure.

In this description, references to “one embodiment” or “an embodiment,” or to “one example” or “an example” in this description are not intended necessarily to refer to the same embodiment or example; however, neither are such embodiments mutually exclusive, unless so stated or as will be readily apparent to those of ordinary skill in the art having the benefit of this disclosure. Thus, a variety of combinations and/or integrations of the embodiments and examples described herein may be included, as well as further embodiments and examples as defined within the scope of all claims based on this disclosure, as well as all legal equivalents of such claims.

This disclosure addresses partitioning a solid state storage device (such as flash, phase change memory (PCM), DRAM, etc.) to create multiple virtual storage devices. The disclosure also addresses self-tiering of the data between the multiple virtual tiers within the physical device. And some examples provide for automatic movement of aging data blocks (i.e. data blocks for which a pre-set write threshold has been exceeded) to larger over-provisioning (OP) pools of blocks to reduce the rate of aging for those blocks.

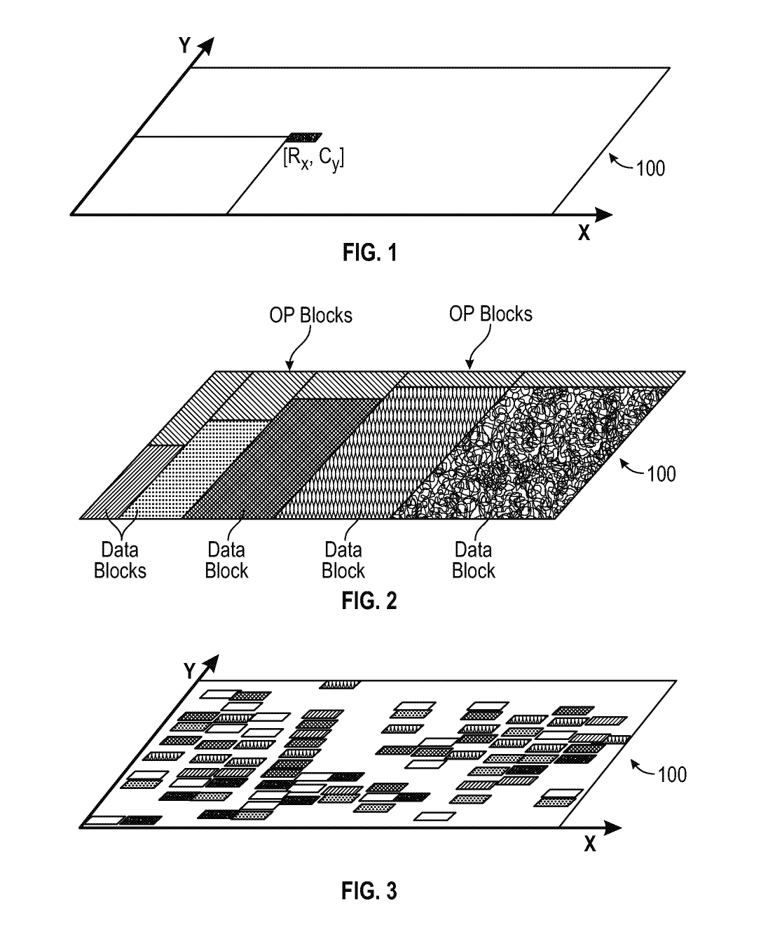

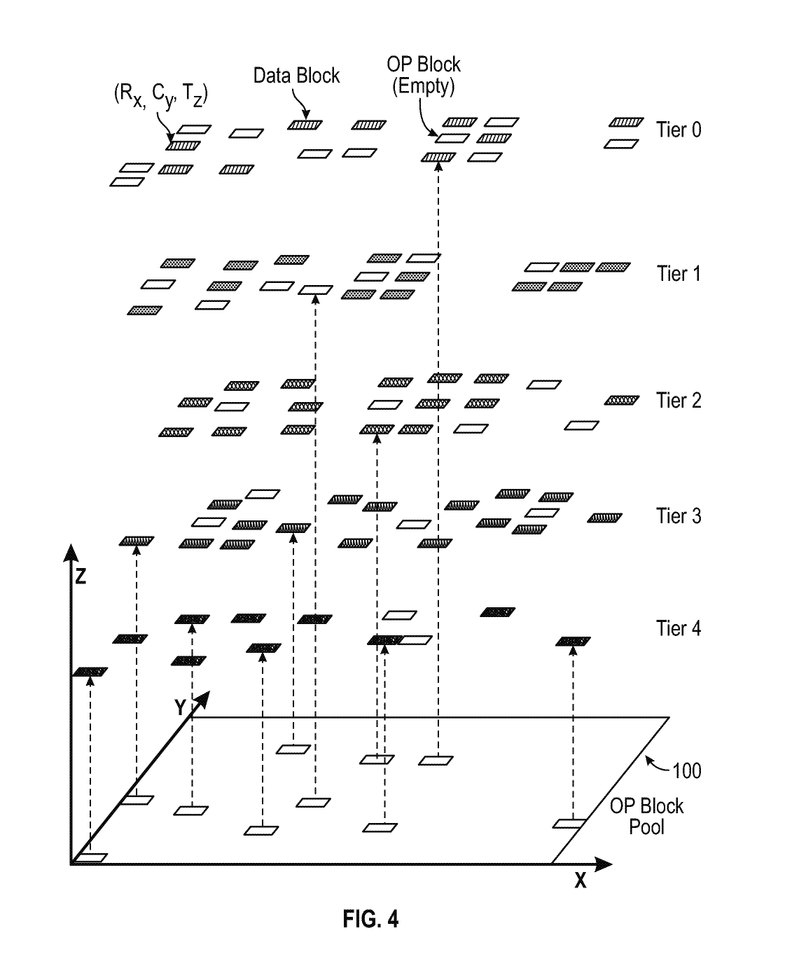

With respect to the partitioning of a physical storage device (FIG. 1) to form multiple virtual storage devices, as depicted in FIG. 2 (logical address view) and FIG. 3 (physical address view), the physical device 100 is partitioned into multiple virtual devices. Referring now also to FIG. 4, each tier includes a dynamic virtual data pool (formed by the cross-hatched blocks) and a dynamic, virtual over-provisioning pool (formed by the open blocks, creating multiple virtual storage tiers within that device. In the described example, virtual tier devices are implemented as Tz (the “Height,” (or Z axis if imagined as a 3D Topology), yielding an order is the six different ideas is a sum of the Rx*Cy*Tz topology with multiple virtual tiers, in which Rx=the row address; Cx=the column address; and Tz=the virtual tier level tier (individually referred to herein as Tn, where n=the individual virtual tier number).

In selected embodiments, each virtual tier will have a different ratio of Data Blocks (user data), and Over Provisioning Blocks (OP Blocks), which will result in different performance and durability characteristics for each tier within that physical storage device, increasing the over-all performance of the device and the longevity of the solid state storage media. For example, the ration of multiple virtual storage devices can, in some embodiments, increase the performance and the life of the storage device by placing the most accessed data in the most over-provisioned tier; result in higher reliability of system and better longevity of the physical device; and/or result in more consistent, predictable performance. For example, in some embodiments, high write mix environments may have critical data automatically placed for best performance; and/or writes may be optimized, resulting in improved write and read performance.

With respect to the self-tiering of data, a data access rate (write rate, or write rate and read rate) score will be tracked for each logical user data block (based on host allocation, stored as per block metadata), and an access rate threshold for each virtual tier will be set. Once a logic block access rate exceeds its threshold for that tier, on the subsequent write, the data will be written to the next tier. This will also enable a natural identification of the most accessed and least accessed data within the device, for easier external data management and system tuning. The result will be more streamlined system architectures and simpler tiering implementations, which will provide for optimized storage usage, increased performance, and improvements in system longevity.

For example, the described virtual storage device creates Tn virtual tiered devices within a storage device, and allows for Tn virtual pools of user data and over-provisioned space of varying capacity to be made available as over-provisioned write space for each virtual storage device. Tn is the number of virtual tiers contained within the virtual storage device. Write count thresholds are set for each virtual storage device, and if a write count threshold is exceeded for a given physical block within that storage pool, on the next write to the logical address associated to that physical address, that write will be targeted to an open block within that tier, and the physical block will be re-located to the next higher virtual tier (which has a smaller over-provisioned block pool). Concurrently, unused, unallocated over-provisioned blocks are available to replenish the block moved from that tier based on the pre-defined “replenish policy.”

An additional capability that may be implemented in selected embodiments of the described system facilitates tiering based on data access. In embodiments in which this functionality is implemented, Every write to a host based logical address results in an additional write to the write count algorithm used (e.g., Wcount=Wcount+1). Once the pre-set logical address write count exceeds the pre-programmed threshold, on the next write, that logical address is re-located to the next lower virtual tier (which has a higher percentage over-provisioned capacity), and that physical address is now associated with that next lower virtual tier, and will be managed by that tier's processing parameters.

This means that the more active, or “hotter,” data is written to the next larger virtual pool of storage, which has a larger over-provisioned capacity, and will result in higher performance as there is less write contention (lower write-amplitude impact due to less write related processes related to freeing up write blocks) in pools with larger over-provisioned capacity.

For example, may be implemented to provide one or more of the following functions. “Hotter” data (more highly accessed data) percolates up (to a lower # tier), while less accessed (“colder”) data stays in its current tier, or falls down to a higher number tier. Thus, the “hottest” data tier is T0, and the next “hottest” data tier is at T1; while the next to last “coldest” data is at Tmax−1, and the “coldest” data is at Tmax. Easy identification of and access to the “hottest” and “coldest” tiers within that device may allow for the Host computer element to more easily relocate “hot” or “cold” tiered data to a different, and in some cases more efficient, storage device. Policies can be written to deploy reserved/un-allocated Over Provisioning Blocks (OP Blocks); once the threshold for that pool has been exceeded, or the remaining block count has been reduced below the number of blocks required by that OP pool. Once the available storage in the reserved/un-allocated OP blocks dips below a threshold, additional storage devices such as Flash devices (e.g., Flash DIMMs) can be added, injecting fresh flash into the system.

For example, one capability that may be implemented in systems as described herein is to enable the device improve the efficiency of utilizing its over-provisioned capacity by locating hotter data to a tier with larger OP pools, resulting in colder data remaining in a tier with smaller OP pools, resulting in an overall net gain in device performance and device longevity.

A by-product of this topology allows you to alternatively (and easily) identify and move the hotter data to another, more efficient storage element (if a preset threshold is breached), thereby removing the impact on wear out for that device by the hottest data of that device. Typically the hottest data would be moved to a memory element closer to the host processing element, and preferably to a storage element a life that is less write-limited. In the same manner, colder (less accessed) user data can be easily identified and moved to a more efficient storage element (for example, a Hard Disk Drive, which is likely more economically more efficient).

The Storage Device that that is partitioned into multiple virtual tiers may be single ported (one bi-directional interface for data transfer, device management, etc.), or could be multi-ported (multiple access ports).

Each virtual storage device has its own Data Blocks (depicted as patterned blocks) and virtual tier over-provisioned Blocks (depicted as blank blocks). Different topologies can be used to set the number of Data Blocks and OP Blocks in each virtual tier. For example:
Fixed Counts: Each tier is initialized with a fixed count of Data Blocks and a fixed count of OP Blocks;
Fixed Ratio: A fixed Ratio of OP Blocks to Data Blocks
Fixed %: A fixed % of OP Blocks to Data Blocks
Dynamic: virtual tiers can grow and shrink over time, for example: (a) as Hotter/Colder Data Blocks are moved to/from a virtual tier based on exceeding their tier's thresholds, or (b) as Physical OP Blocks are moved to/from that virtual tier's Over Provisioning Pool.

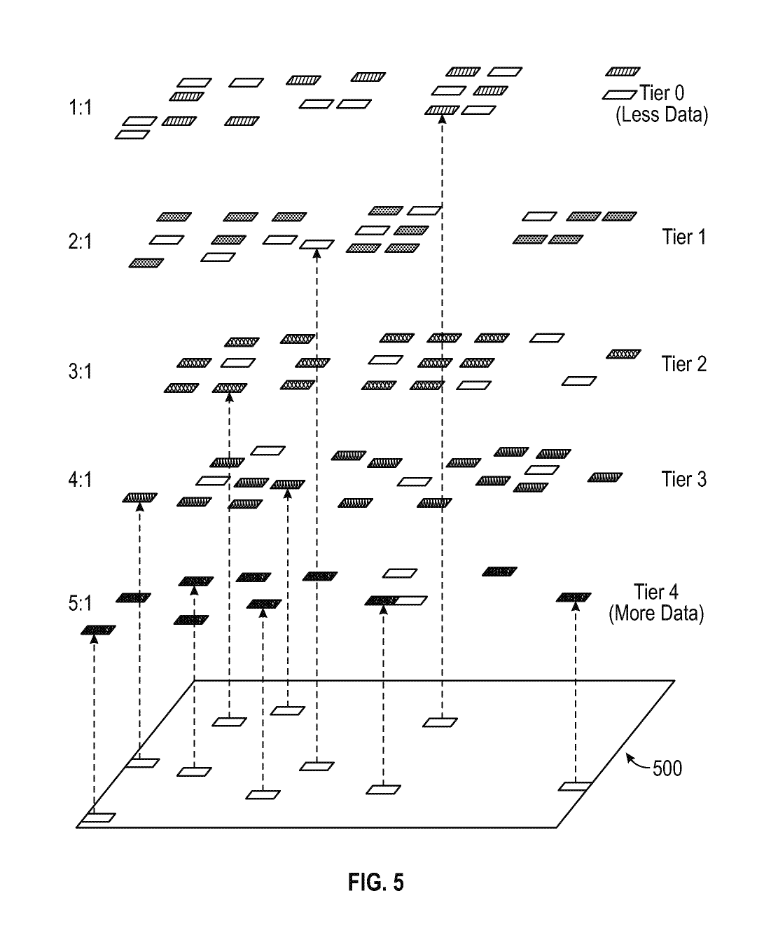

Referring now also to FIG. 5, The figure depicts an example of a multiple virtual tier storage device 500 using data block to OP Block ratios to allocate blocks to the 4 virtual tiers. The data at T0 can remain at T0 until T0 becomes “near” full (such as by reaching a pre-set threshold), at which point, under the control of the Device/Host/Admin memory controller, the host/admin can manage the movement of that data from that storage device to a more efficient storage element for that tier of data. The offloaded data will allow the Host to trim the removed data from that device, making those cells available for the OP Pool.

Additionally, in some embodiments, the storage device can allocate unused, fenced off OP blocks to any virtual tier that requires additional OP to maintain its performance requirements. In addition, in some embodiments, fresh storage DIMMs can be added to the fenced off OP pool, either by being physically added, or by being made electrically available to the storage device.

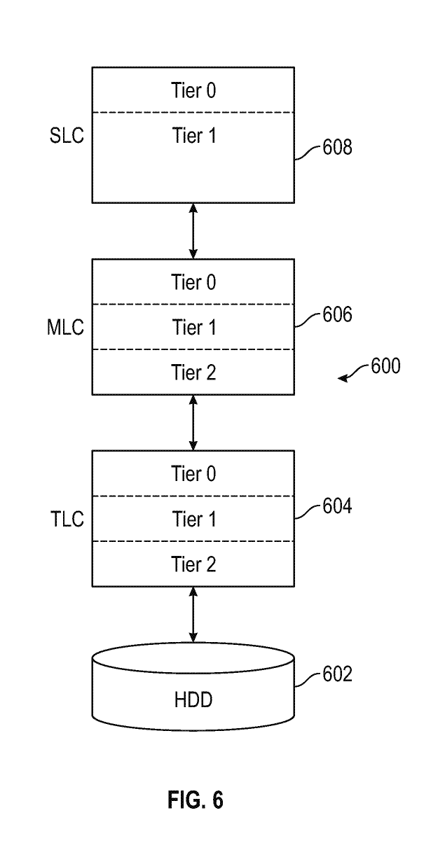

Referring now also to FIG. 6, the figure depicts an example assembly 600 of multiple storage devices, including a hard disk drive 602, triple level cell (TLC) flash SSD 604, multi-level (two level) cell MLC) flash SSD 606 and single level cell (SLC) flash SSD 608, all conceptually arranged in a stack, with each of the solid-state SSD devices 604, 606 and 608 having multiple virtualized storage tiers, as described herein. Data at any tier can be easily identified for movement to any other physical storage element outside of that storage element (movement managed by an external processing element). For example, a policy can be set that will automatically move the coldest data to a more efficient storage element. In this example, data in virtual storage of TLC SSD 604 at T2 can potentially be moved to a lower cost/lower spindle speed HDD 602.

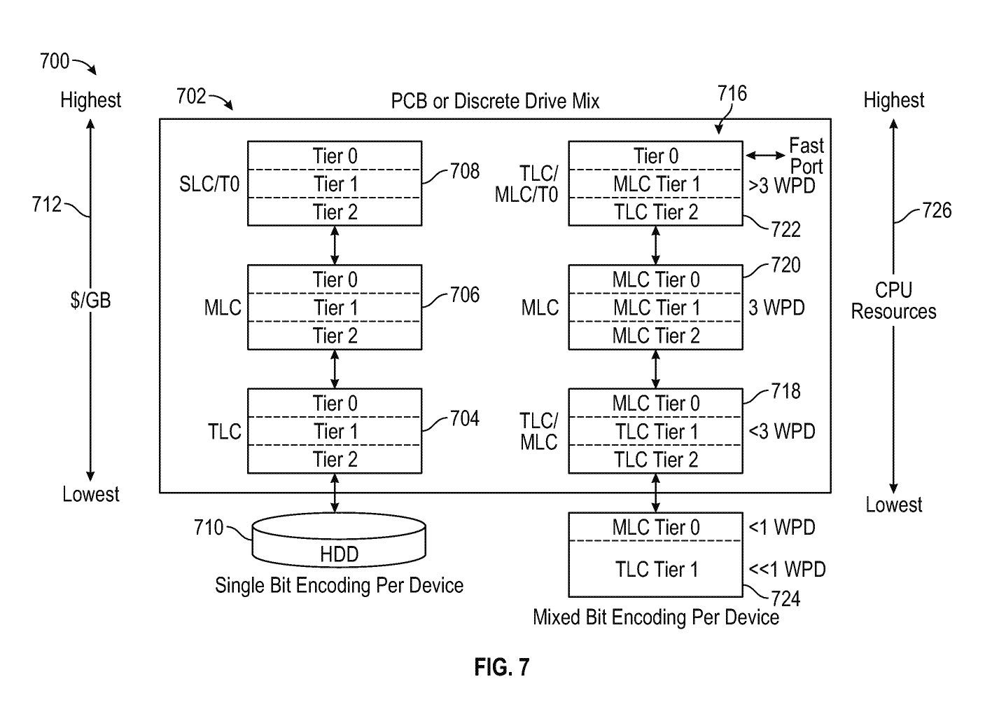

Referring now to FIG. 7, the figure depicts a schematic representation of an example embodiment 700 of solid-state storage devices with mixed storage media, arranged in conceptual stacks, once again. A first stack indicated generally at 702 is similar to that of FIG. 6, as it includes a TLC SSD 704, and MLC SSD 706, and an SLC SSD 708, all arranged in a conceptual stack (either on a printed circuit board (PCB), or as a mix of discrete drives), relative to an HDD 710. As depicted, the storage devices are arranged ascending in the order of increased relative cost per gigabyte (GB) of storage, as indicated at 712. A second stack, indicated generally at 716, includes physical devices of mixed bit encoding per device, with TLC/MLC SSD 718, MLC SSD 720, and TLC/MLC SSD 722, each SSD having three vertical tiers. The three SSDs each represent a respective writes per day (WPD) capability of the physical device. Second stack 716 is coupled to a separate SSD 724 offering a much lower WPD capability. As can be seen at 726, SSDs 718, 720 and 722 are depicted in an ascending order of demands placed on CPU resources.

The storage system's (that contains a number of virtual and traditional storage elements) processing element would manage the virtual storage device as a single storage device, allocating storage on that device as required. Various options for managing the virtual storage device may be implemented. For example, Hot data percolates up through the layers, from Tmax, to Tmax−1 . . . to T1, and finally to T0. A background policy can be implemented on selected embodiments (which may be run by a virtual storage device processor element), that compares the “heat” of the data to a defined threshold. Cold data settles down to the next level once N_{thresholds} are reached for Nₘₐₓ cells on that level. Another option would be real-time assignment of a virtual OP pool that could be dynamically reallocated to another virtual tier in order to temporarily increase the performance of that tier by reducing write bottlenecks for that tier.

Devices can be chained, where T0 (most active, data) of one device becomes Tmax (least active data) of its chained device; data movement between links in chain can be facilitated by an independent processing element. Employing this architectural schema in a Flash based storage device would also allow for defining some tiers to operate as SLC tiers, MLC tiers, TLC tiers, and higher bit densities, resulting in extended performance and endurance possibilities. Since SLC is inherently more reliable than MLC, dynamically converting aged devices (no user data present) from TLC to MLC or SLC, or MLC to SLC may extend the life of those devices in certain topologies. Since such conversion will likely result in some data loss, the conversion should be performed on OP blocks, i.e., blocks containing no user data.

In implementing the described system, a non-blocking architecture may be preferred for many embodiments in order to maximize performance, but would not be required. In some embodiments, a dedicated write engine per virtual drive layer may be preferred in order to maximize performance, but would not be required. Finally, as noted elsewhere herein, by moving aging OP blocks “down the stack,” storage can be replenished by replacing retired blocks with fresh blocks.

With respect to the automatic movement of aging blocks, allocated to that tier in which the aging OP block has been relocated in order to replenish the OP pool for that tier. In order to further replenish the storage device, new storage memory modules can replace aged or “retired” memory modules. Replenished modules can be physically added (unplugging “retired” modules, replaced by “virgin” modules, or just adding more virgin modules) or by electrically disconnecting retired modules, and electronically connecting virgin modules.

Additionally, a memory partitioned into multiple virtual storage devices as described herein may be controlled to provide any one or more of the following functions and/or advantages: provide aid in managing end of life transitions and migration of data from physical storage devices that are approaching their end of life as max write counts expire or are approaching expiration for a pre-defined percentage of all blocks. Additionally, over time, as a tier approaches its maximum write count, the Max Write Threshold can be reduced, which will result in accelerating the movement of more frequently accessed data off of that tier.

Additionally storage modules (e.g. such as Flash DIMMs) that are approaching their end of life can be “cleaned and replaced.” Once live data is moved off of the aging module, it can be dynamically pulled (hot unplugged) from that OP pool, and replaced (hot plugged) with virgin storage media, or electrically isolated (aged media) and electrically enabled (new media).

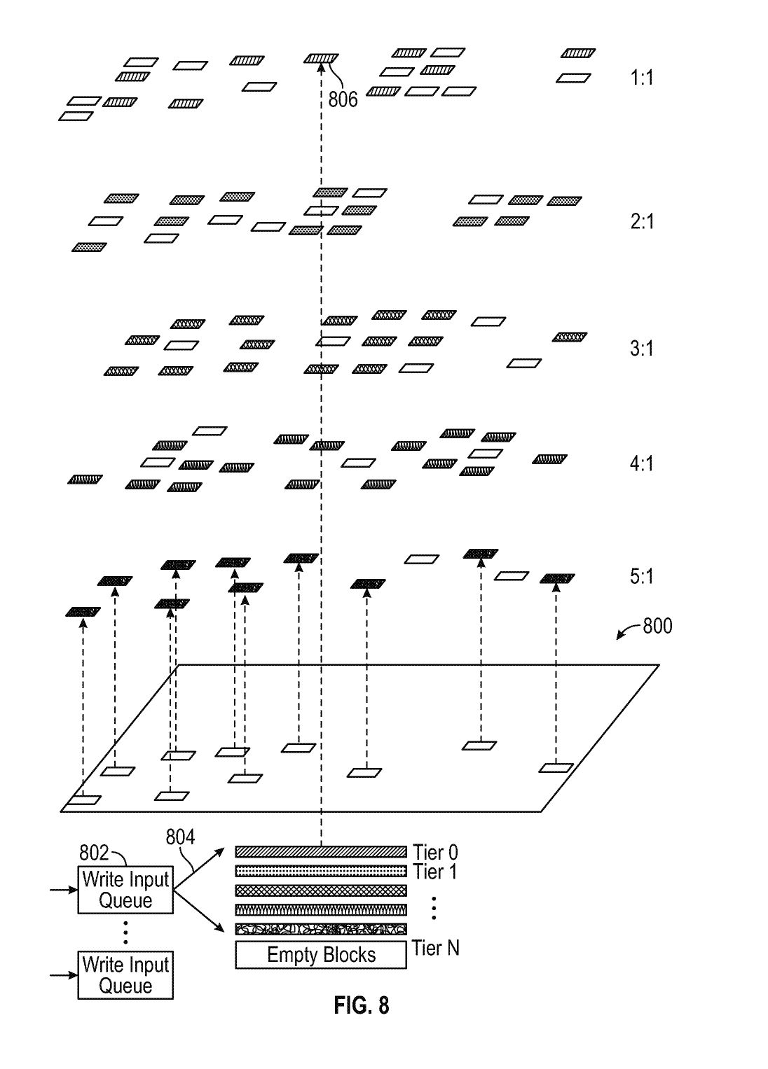

Referring now to FIG. 8, the figure depicts the host writing data to the over-provision virtual storage device, indicated generally at 800. Incoming writes are buffered, as indicated at 802, and a virtual address (Rx*Cy*Tz), further defined by tier is assigned, as indicated at 804; and the block now belonging to that assigned tier (in this example T0) is then moved to that tier, as indicated at 806. An empty block is then returned to the right input queue replacing a previously written block.

The described automatic tiering may also be implemented to enable a simpler tiering solution whereby the device not only governs itself, optimizing its active life, but also offloading from the host the need to maintain large, complex data movements, freeing up CPU cycles for higher level tasks. For storage arrays containing many devices, if system level performance tuning is required, data may be offloaded (to faster storage access—for performance bound solutions, or to higher capacity access, for capacity bound solutions); and such data requiring re-allocation is pre-defined, and exists either in the highest virtual tier (performance tier), or the lowest virtual tier (capacity tier) for easier identification and movement. Devices can be stacked, where the next highest tier for a device is the lowest tier for the device above it.

User data writes (based on Host logical address) are counted and stored by the storage system for each Host data block address. Different write counting schemes and algorithms can be used to optimize tiering levels and device behavior. Once pre-set max write thresholds (based on host logical addresses) for the current tier that the block resides in are exceeded, the next write for that address is relocated to the next higher capacity over-provisioned tier (next lower tier number, since the lower the tier number, the higher the percentage of over-provisioned capacity).

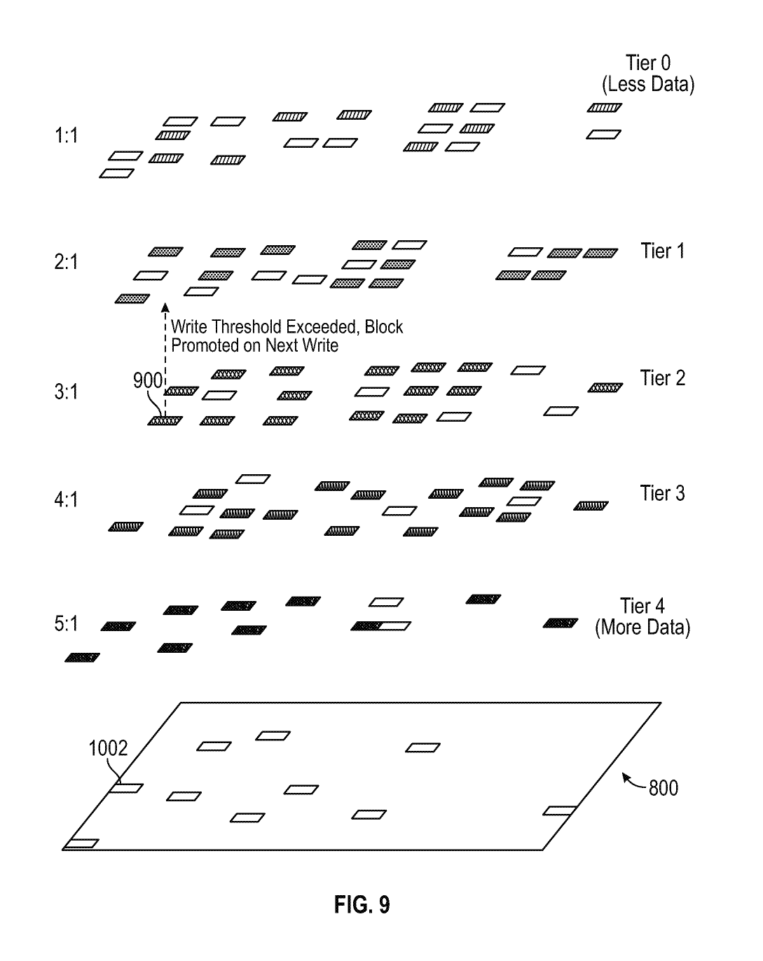

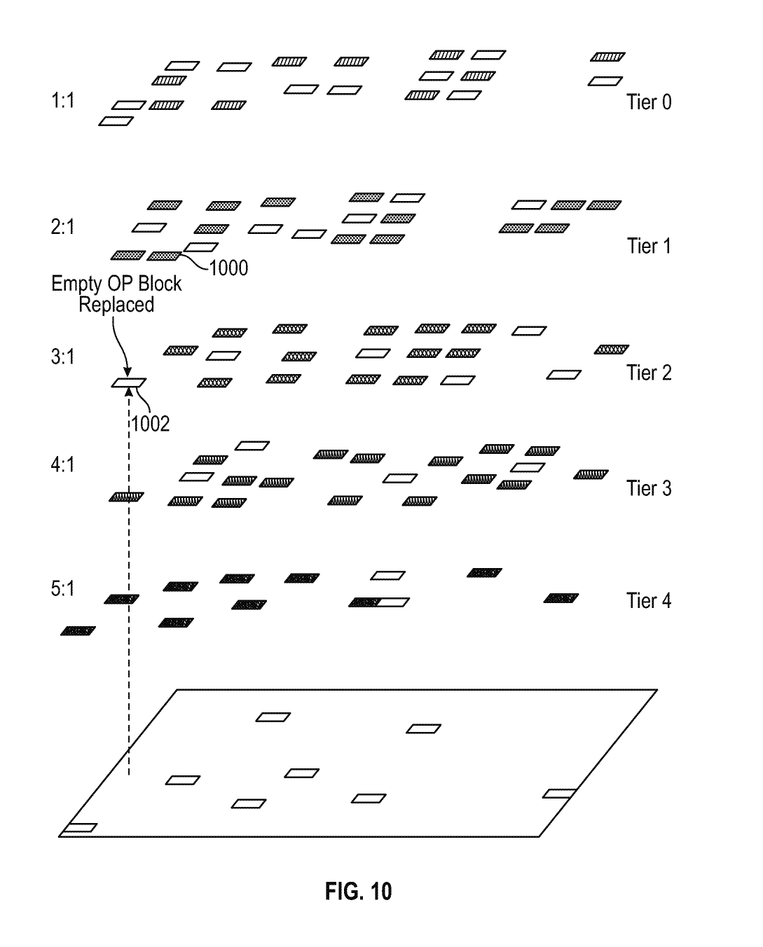

Referring now to FIG. 9, that figure depicts the overprovision virtual storage device 800 of FIG. 8, depicting a first portion of a write promotion of a block to the next tier. Once the controller notes that the write threshold is been exceeded for the identified block 900 in tier 2, on the next right block 900 will be promoted to the next tier. Referring now also to FIG. 10, data block 900 has now been promoted as block 1000 in FIG. 10. Additionally, an empty OP Block 1002 has now been assigned to the virtual address previously applied to block 900 in FIG. 9.

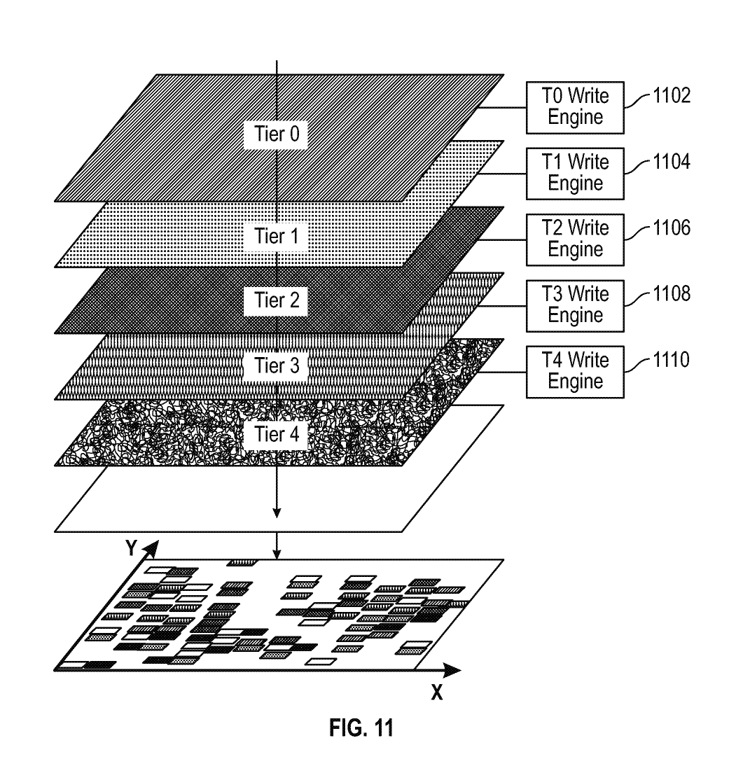

Referring now to FIG. 11, the provides conceptual representation of a virtual storage device 1100 identifying that all reads are performed on the Rx*Cy address, as no knowledge of the virtual tiers is required by the storage system to read (or write) data for any given address. In the example of FIG. 11, each virtual tier has a respective write engine, 1102, 1104, 1106, 1108, and 1110.

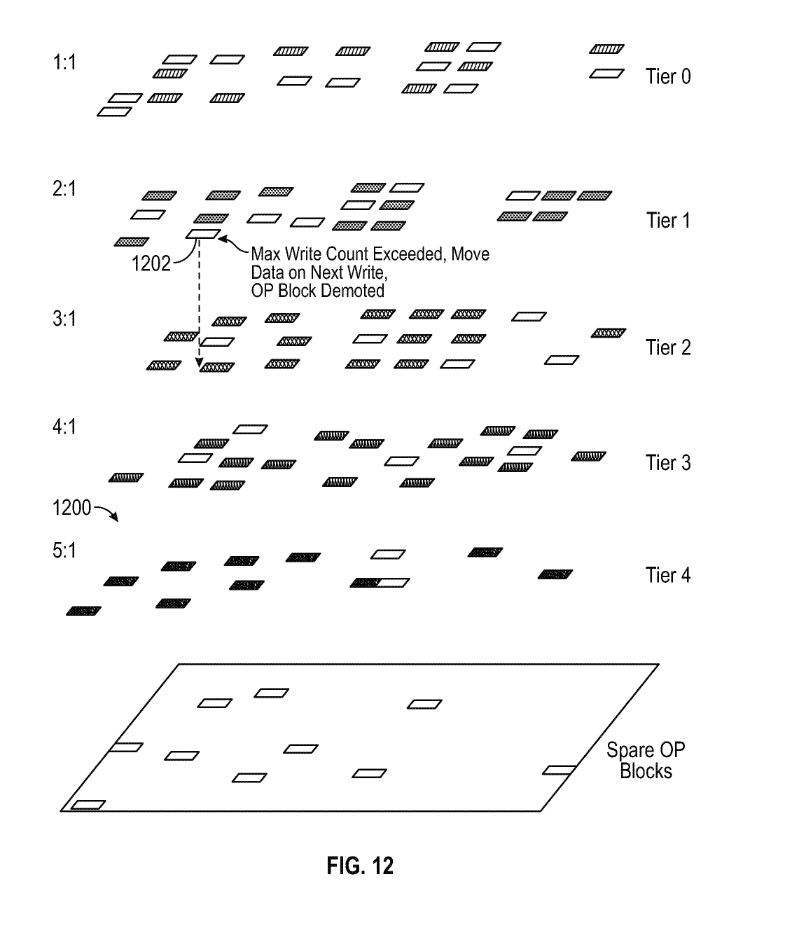

In order to reduce the write loading on any specific block, over-provisioning blocks move to higher capacity over-provisioning pools once max write count thresholds for that physical block's tier are exceeded; and after data has been relocated to another block, that physical block is relocated to the next higher (N+1) tier's OP pool (in this case, T2). Referring now to FIG. 12, the figure depicts an example over-provisioned virtual storage device 1200, depicting the demotion of an over-provision block 1202. In the event that the controller determines that the maximum write count for that tier (Tz) is exceeded, as for block 1202, the block can be demoted to the next highest virtual tier (Tz+1). Then, an OP Block will be moved from the OP Pool to the layer (or tier) from which block 1202 was moved (Tz).

The described self-tiering of blocks and automatically controlled movement of blocks may be implemented to aid in the testing of storage device “end of life” scenario's by artificially forcing end of life conditions for different tiers within the device, making system level assessments of the impact of device wear before the devices actually wear out. In some embodiments, management of each of the virtual tiers can be performed with a dedicated processing element per tier (performing any one or more of: write management, wear leveling, garbage collection, etc.) for that tier. Alternatively, management of each tier can be context switched into one or more processing elements for managing that tier.

Following is an example implementation of operating the described virtualized storage device. The example implementation is constructed on Tn virtual stacked layers (tiers) of identical capacity of Full Capacity (FC)/Tn; where FC=useable capacity (UC)+over-provisioned capacity (OPC).

Maximum Write Thresholds are set between each tier, and once a Max Write

Threshold has been breached for a physical block, data will be relocated from that block, and that block will be relocated to the next tier's Over Provision Pool (OPP).

The goal is to maintain FC/T as constant for each tier (Tn). Once a physical block [R212, C16, T3] exceeds its pre-set Max Write Count for that tier: data is relocated from that block [R212, C16, T3] to an empty block within that tier, for example to [R14, C48, T3]. Once the write completes, block [R212, C16, T3] Cell Empty Flag and Cell Busy Flags are set (the Cell Busy flag blocks that cell from any additional write activity).

Tn (the tier level for OP block [R212, C16, T3]) is then incremented by 1. [Rx, Cy, TZ+1], so [R212, C16, T3] is relocated to [R43, C112, T4], and block [R43, C112] is now physically part of tier 4's (T4) over provisioning pool, and will be managed by T4. Concurrently, Cell Busy Flag is cleared.

Because FC/T wants to remain constant for each Tn, and because T3 now has 1 less OP Block, and T4 now has one more OP Block, T3 will be allocated a new OP Block from the Spare OP Pool, and T4 will donate its lowest write count threshold block to the OP Block Pool.

Commonly known wear leveling algorithms will be used at each Tn level, and can be optimized for their over-provisioned capacity at each level.

Many variations may be made in the structures and techniques described and illustrated herein without departing from the scope of the inventive subject matter. Accordingly, the scope of the inventive subject matter is to be determined by the scope of the following claims and all additional claims supported by the present disclosure, and all equivalents of such claims.

I claim:

1. A method of operating a solid state storage device, comprising:
partitioning the physical device into multiple virtual devices, wherein at least one of the virtual devices includes,
a dynamic data block pool,
a dynamic over-provisioning block pool,
wherein the data blocks and over-provisioning blocks are arranged in multiple virtual tiers, and
wherein each virtual tier has a different ratio of data blocks to over-provisioning blocks relative to other virtual tiers, resulting in different performance characteristics for each virtual tier within the at least one virtual device.

2. The method of claim 1, further comprising:
tracking a data access rate for each data block;
comparing the tracked data access rate for each data block to an access rate threshold for the virtual tier in which the data block is located, wherein each virtual tier has an access rate threshold different from the access rate threshold of other virtual tiers within the at least one virtual device;
when the tracked data access rate for a first data block in a first virtual tier exceeds a threshold for that tier, on the next write to a logical address associated with a physical address of such first data block, writing the data in the next lower virtual tier, thereby effectively moving the first data block to the next lower virtual tier;
wherein the virtual tiers are functionally arranged from a low tier having the greatest proportion of over-provisioning blocks relative to data blocks to a high tier having the lowest proportion of over-provisioning blocks relative to data blocks.

3. The method of claim 2, further comprising:
writing a physical address associated with the first data block, for which the tracked data access rate exceeded the threshold, to the over-provisioning pool; and
allocating a block from the over-provisioning pool to the first virtual tier in which the first data block was previously located.

4. The method of claim 3, wherein the physical address associated with the first data block is associated with a logical address for the next higher virtual tier

5. The method of claim 1, further comprising:
tracking a data access rate for each data block;
comparing the tracked data access rate for each data block to an access rate threshold for the virtual tier in which the data block is located, wherein each virtual tier has an access rate threshold different from the access rate threshold of other virtual tiers within the at least one virtual device;
when the tracked data access rate for a first data block in a first virtual tier exceeds a threshold for that tier, on the next write to a logical address associated with a physical address of such first data block, writing the data to an open block within the first virtual tier.

6. The method of claim 2, wherein the more active data is written to relatively lower virtual tiers than less active data.

7. The method of claim 2, wherein each virtual tier has a respective access threshold that is different from the access threshold of each other virtual tier.
